(19) United States
(12) Patent Application Publication
(10) Pub. No.: US 2022/0335361 A1
(43) Pub. Date: Oct. 20, 2022

(54) Territory Assignment Optimization

(71) Applicant: AT&T Intellectual Property I, L.P., Atlanta, GA (US)

(72) Inventors: Brian Lois, McKinney, TX (US); Caitlin Gruis, Centerville, OH (US)

(73) Assignee: AT&T Intellectual Property I, L.P., Atlanta, GA (US)

(21) Appl. No.: 17/235,201

(22) Filed: Apr. 20, 2021

(51) Int. Cl. G06Q 10/06; G06F 16/28; G06F 16/29

(52) U.S. Cl. CPC G06Q 10/063114; G06Q 10/063112; G06F 16/285; G06F 16/29

(57) ABSTRACT

The concepts and technologies disclosed herein are directed towards territory assignment optimization. According to one aspect disclosed herein, a territory assignment optimization system can receive job data that identifies a plurality of jobs at a plurality of customer locations throughout a geographical area. The system can also receive one or more clustering parameters. The system can identify, via execution of a data clustering algorithm, a plurality of job dense areas within the geographical area based upon the job data and the clustering parameters. The system can reduce a size of at least one territory of a plurality of territories. Each territory can include a portion of the plurality of job dense areas. The system can also conditionally exchange an assignment of at least one of the plurality of job dense areas from a first territory of the plurality of territories to a second territory of the plurality of territories.

### BACKGROUND

Today, in addition to utilities such as electricity, gas, and water, services such as landline telephone, Internet, and television have become essential for many customers. These services often require installation of equipment at the customer's location (e.g., home or business). For this reason, service technicians are sent to the customer's location to install new equipment, repair existing equipment, and/or perform maintenance on existing equipment.

Service providers may deploy a network of distribution centers designed to ensure that service technicians are available to serve customers in different geographical areas. Typically, a supervisor with local knowledge of the geographical areas will assign territories to each distribution center, individual service technician, or team of service technicians. Other things being equal, the service provider would prefer the nearest service technician to serve each customer. This approach can reduce drive time, fuel costs, vehicle wear and tear, and vehicle depreciation. The closest distribution center, however, may not always have enough service technicians to satisfy customer demand. The supervisor therefore needs to balance the number of available technicians with the forecasted volume of work in a given territory.

### SUMMARY

Concepts and technologies disclosed herein are directed to territory assignment optimization. According to one aspect disclosed herein, a territory assignment optimization system can receive job data that identifies a plurality of jobs at a plurality of customer locations throughout a geographical area. The territory assignment optimization system can receive one or more clustering parameters. The clustering parameters can include a distance measurement and a number of points. The distance measurement can be a distance from a specific location, such as, for example, a starting location of a service technician. The number of points can identify a number of other jobs that should be within the distance from the specific location. The specific location can include a technician starting location such as a technician distribution center. The territory assignment optimization system can identify, via execution of a data clustering algorithm, a plurality of job dense areas within a geographical area based upon the job data and the clustering parameters. In some embodiments, the data clustering algorithm can be a density-based spectral clustering of applications with noise (“DBSCAN”) algorithm. The territory assignment optimization system can reduce a size of at least one territory of a plurality of territories. Each territory of the plurality of territories can include a portion of the plurality of job dense areas. The territory assignment optimization system can conditionally exchange an assignment of at least one of the plurality of job dense areas from a first territory of the plurality of territories to a second territory of the plurality of territories.

In some embodiments, the clustering parameters can also include a maximum size. The territory assignment optimization system can reduce the size of the territory based upon the maximum size. In some embodiments, the territory assignment optimization system can reduce the size of the territory based upon the maximum size via execution of a Gaussian mixture clustering algorithm.

In some embodiments, the territory assignment optimization system can conditionally exchange the assignment of at least one of the plurality of job dense areas from the first territory of the plurality of territories to the second territory of the plurality of territories if the exchange improves a balance of a number of jobs to a number of technicians among the first territory and the second territory. In some embodiments, the territory assignment optimization system can conditionally exchange the assignment of at least one of the plurality of job dense areas from the first territory of the plurality of territories to the second territory of the plurality of territories if the exchange improves a distance between at least one job of the plurality of jobs and a nearest technician.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a block diagram illustrating aspects of an illustrative operating environment for various concepts and technologies disclosed herein.

FIG. 2 is a flow diagram illustrating aspects of a method for optimally assigning territories to technicians, according to an illustrative embodiment of the concepts and technologies disclosed herein.

FIG. 3A is a map diagram illustrating job dense areas identified by a territory assignment optimization system, according to an illustrative embodiment of the concepts and technologies disclosed herein.

FIG. 3B is a map diagram illustrating Gaussian mixture clusters determined by the territory assignment optimization system, according to an illustrative embodiment of the concepts and technologies disclosed herein.

FIG. 3C is a map diagram illustrating territory re-assignment determined by the territory assignment optimization system, according to an illustrative embodiment of the concepts and technologies disclosed herein.

FIG. 3D is a map diagram illustrating the application of a constraint to reassign job dense areas, according to an illustrative embodiment of the concepts and technologies disclosed herein.

FIG. 4 is a block diagram illustrating an example computer system capable of implementing aspects of the concepts and technologies disclosed herein.

FIG. 5 is a block diagram illustrating an example mobile device capable of implementing aspects of the concepts and technologies disclosed herein.

FIG. 6 is a block diagram illustrating a virtualized cloud architecture capable of implementing aspects of the concepts and technologies disclosed herein.

FIG. 7 is a block diagram illustrating an example network capable of implementing aspects of the concepts and technologies disclosed herein.

FIG. 8 is a block diagram illustrating an example machine learning system capable of implementing aspects of the concepts and technologies disclosed herein.

### DETAILED DESCRIPTION

The concepts and technologies disclosed herein are directed to territory assignment optimization. In particular, the concepts and technologies disclosed herein introduce a novel algorithm that assigns territories to drivers within a given geographic area in an optimized way. The novel algorithm incorporates a combination of unsupervised clustering methods and local search optimization methods. Briefly, the disclosed solution for territory assignment optimization can first identify areas of high job density using a clustering algorithm, such as, for example, density-based spectral clustering of applications with noise (“DBSCAN”). Job density is based on the number of jobs within a certain distance from a starting location. The parameters for a number of jobs within a time period and a distance from a starting point can be changed a customized for a given implementation. For example, 300 jobs over a period of 20 days within 5 miles of the starting location may work well for certain implementations. Next, territories that are too geographically large are separated using Gaussian mixture clustering. What constitutes too geographically large can be determined for a given implementation. For example, a territory greater than 150 miles on the diagonal of the smallest bounding rectangle may be considered too geographically large for certain implementations. After territories are assigned, a form of local search-based optimization can be used to exchange the assigned territory of an area that is on the boundary between two territories if the exchange improves either: (1) The balance of jobs and service technicians in the territory (e.g., 2 jobs per service technician per day, although this can be customized as needed); or (2) The distance between a job and the nearest service technician in the assigned territory. Lastly, hard constraints can be applied specific to a given implementation. This can serve as a sanity check for the result of the territory assignment optimization.

Although aspects of the concepts and technologies disclosed herein are described specifically in context of service technician deployment, the benefits of the disclosed solution are applicable to any use case in which resources are routed to geographical areas. For example, shipping companies and food delivery services may benefit from the concepts and technologies disclosed herein. Accordingly, the description of service technician deployment should not be construed as being limiting in any way.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

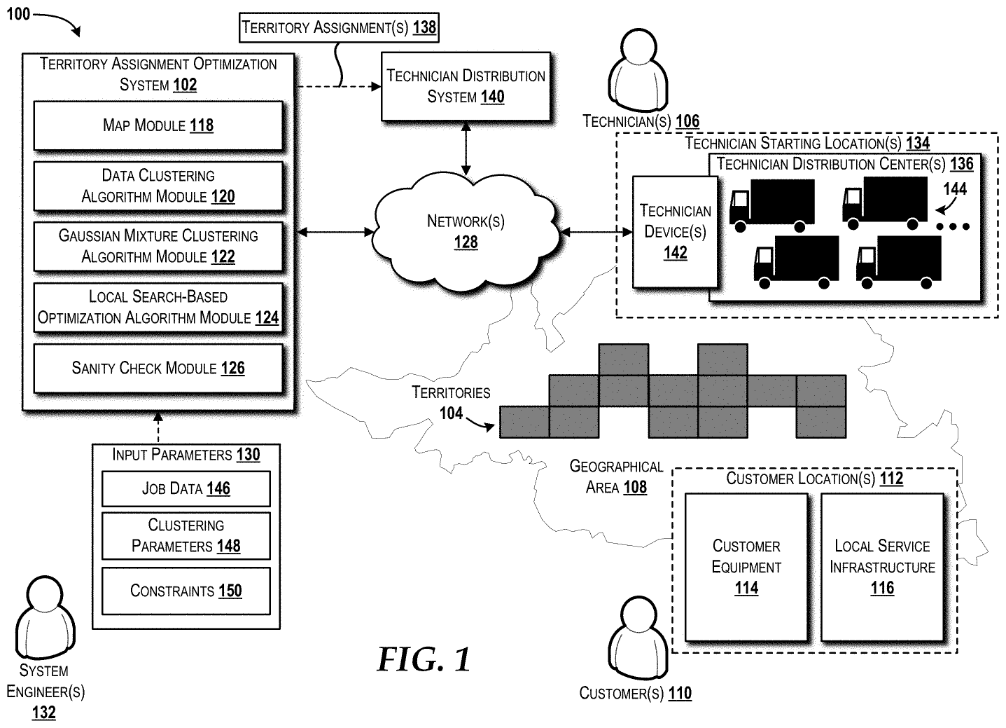

Turning now to FIG. 1, an operating environment 100 in which embodiments of the concepts and technologies disclosed herein will be described. The operating environment 100 includes a territory assignment optimization system 102 that implements a novel algorithm to assign one or more territories 104 (hereinafter referred to collectively as “territories 104” or individually as “territory 104”) to one or more service technicians 106 (hereinafter referred to collectively as “technicians 106” or individually as “technician 106”) within a geographical area 108 (e.g., country, region, state, city, or other municipality) in an optimized way. The territories 104 are shown as rectangles in the illustrated example but in practice can be any shape. The territories 104 may also be referred to as “routing areas.” The technicians 106 can work for, be contracted by, or can otherwise be associated with a service provider that provides one or more services to one or more customers 110 (hereinafter referred to collectively as “customers 110” or individually as “customer 110”). The customer 110 can be an individual, a family, a group of customers, a neighborhood, a business, a government body, or any other entity that is at least partially responsible for requesting that the service be provided at the customer location 112. The customer 110 may request the service themselves or may have the service requested on their behalf.

The customers 110 can be associated with one or more customer locations (also known as service locations) 112 (hereinafter referred to collectively as “customer locations 112” or individually as “customer location 112”) at which customer equipment 114 is to be installed, repaired, replaced, or otherwise serviced by the technicians 106. The customer location 112 may be a home or a place of business of the customer 110. The customer location 112 may be any other location at which service is to be provided. The customer location 112 therefore may be associated with a physical address, latitude/longitude coordinates, a landmark, a mile marker, a city/county/state/country border, or the like that may be useful to the technician 106 in locating the customer location 112. In some embodiments, the customer location 112 is identifiable by a common language location identifier (“CLLI”) (also known as CLLI codes). The CLLI codes can identify network locations such as central office buildings, business and commercial, base station structures, terrestrial radio structure, and the like. The CLLI codes also can identify network support sites such as international borders, end points, fiber nodes, cable junctions, facility junctions, manholes, repeaters, poles, and the like.

The customer equipment 114 can be or can include anything that is used to at least partially provide the service to the customer 110 at the customer location 112. As such, the customer equipment 114 can include customer premises equipment (“CPE”) such as an Internet modem, router, modem/router combination, switch, antenna, satellite dish, set-top box, remote control, combinations thereof, and/or the like. The customer equipment 114 alternatively or additionally may include batteries, power supplies, wire, cable (e.g., fiber optic, copper, or coaxial cable), Ethernet cable, conduit, and/or other equipment that is used to provide the service to the customer 110 at the customer location 112. As described herein, the customer equipment 114 can be installed, repaired, replaced, or otherwise serviced by the technician 106. The customer equipment 114 may be owned by the service provider, the customer 110, or it may be jointly owned. The customer equipment 114 may be provided to the customer 110 for free, a one-time fee, or a recurring fee (e.g., a monthly or yearly fee). It should be understood that the concepts and technologies disclosed herein can be implemented regardless of any contractual obligations between the customer 110 and the service provider. As such, any particular business arrangement that may be representative of a contract is merely exemplary, and should not be construed as being limiting in any way.

The customer location 112 can additionally include, at least in part, a local service infrastructure 116, such as a portion of last mile cabling, equipment, and the like, that is used by the service provider to provide the service to the customer 110 at the customer location 112. The technicians 106 can install, repair, replace, or otherwise service the local service infrastructure 116.

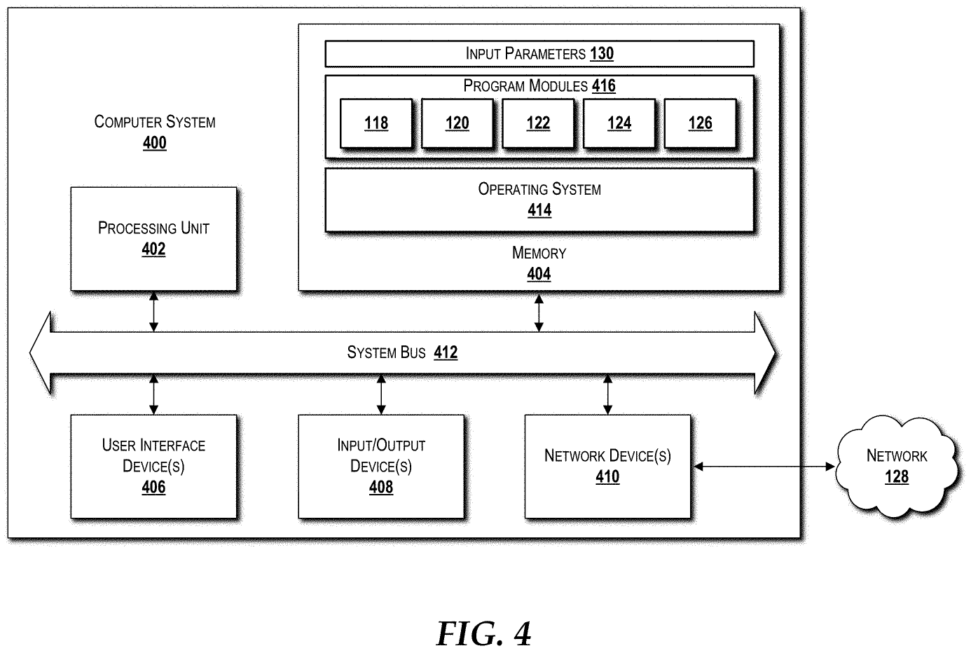

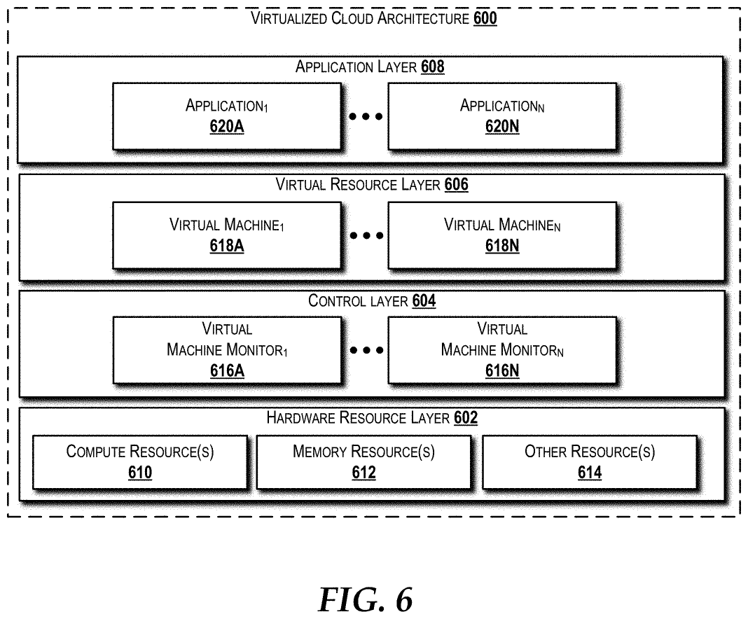

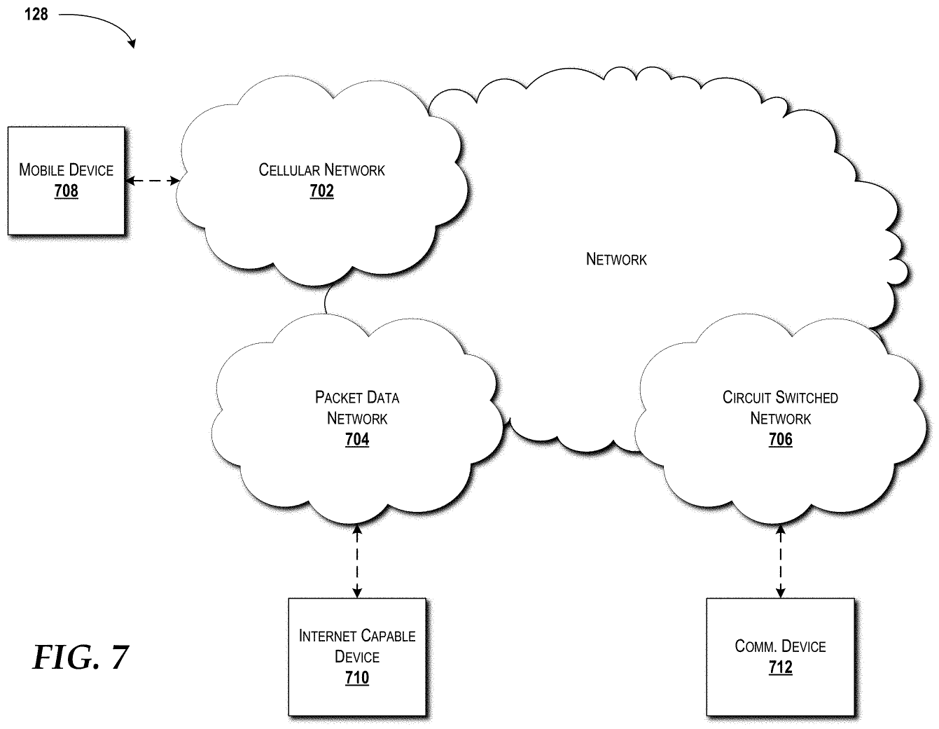

The territory assignment optimization system 102 can execute, via one or more processing components (best shown in FIGS. 4 and 6), a plurality of modules, including a map module 118, a data clustering algorithm module 120, a Gaussian mixture clustering algorithm module 122, a local search-based optimization algorithm module 124, and a sanity check module 126, each of which can include instructions that, when executed by the processing component(s) of the territory assignment optimization system 102, cause the territory assignment optimization system 102 to perform operations described in further detail herein. Although these modules are shown as separate modules, two or more of these modules can be combined, for example, in one or more applications executed by the territory assignment optimization system 102. Moreover, it is contemplated that these modules may be executed by other systems that operate remote from and in communication with the territory assignment optimization system 102 via one or more networks 128 (best shown in FIG. 7), including local and/or wide area networks, for example.

The territory assignment optimization system 102 can, in some embodiments, receive one or more input parameters 130 (hereinafter referred to collectively as “input parameters 130” or individually as “input parameter 130”) from one or more system engineers 132 (and/or other entity) (hereinafter referred to collectively as “system engineers 132” or individually as “system engineer 132”). The input parameters 130 can define, for example, a number of jobs within a time period and a distance from one or more technician starting locations 134 (hereinafter referred to collectively as “technician starting locations 134” or individually as “technician starting location 134”), such as one or more technician distribution centers 136 (hereinafter referred to collectively as “technician distribution centers 136” or individually as “technician distribution center 136”) or other location (e.g., a service technician's home). For example, 300 jobs over a period of 20 days within 5 miles of the technician starting location 134 may work well for certain implementations. The input parameters 130 can include other parameters such as a definition for a maximum territory size. For example, the territory 103 greater than 150 miles on the diagonal of the smallest bounding rectangle may be considered too geographically large for certain implementations. The input parameters 130 may be fixed (e.g., pre-defined and set) or variable.

The output of the territory assignment optimization system 102 is one or more territory assignments 138 (hereinafter referred to collectively as “territory assignments 138” or individually as “territory assignment 138”) that can be provided to a technician distribution system 140 that, in turn, can notify the technicians 106 of the territory assignments 138. In some embodiments, the technician distribution system 140 can notify the technicians 106 of the territory assignments 138 via email, text message, proprietary message, application message (e.g., a dispatch application), telephone call, any combination thereof, and the like, which can be received by the technicians 106 via one or more technician devices 142 (hereinafter referred to collectively as “technician devices 142” or individually as “technician device 142”). The technician distribution system 140 may be remotely located from the technician distribution centers 136 as shown or may be co-located. Other ways in which the technician distribution system 140 can notify the technician(s) 106 of the territory assignment(s) 138, including via physical media (e.g., paper dispatch notes) are contemplated. Moreover, although the technician distribution system 140 is shown separate from the territory assignment optimization system 102, the functionality of the technician distribution system 140 may be combined with the functionality of the territory assignment optimization system 102.

The technician device 142 can be a mobile telephone, a smartphone, a tablet, a smart watch, a fitness device, a pair of smart glasses, an augmented reality (“AR”) device, a virtual reality (“VR”) device, a computer of any form factor, another computing device, an Internet of Things (“IoT”) devices, an unmanaged or managed (e.g., by the service provider) devices, and/or the like. It should be understood that the functionality of the technician device 142 can be provided by a single device, by two or more similar devices, and/or by two or more dissimilar devices.

The technicians 106 can travel from the technician starting locations 134 to the customer locations 112 via one or more vehicles 144 (hereinafter referred to collectively as “vehicles 144” or individually as “vehicle 144”). The vehicle 144 can be a car, truck, van, or any other vehicle. The vehicle 144 can be part of a fleet of vehicles that the service provider maintains for the technician 106 as part of his/her employment or contract. The vehicle 144 alternatively can be individually owned and/or operated by the technician 106. In some embodiments, the vehicle 144 is a driver-operated vehicle and is manually driven by the technician 106. In some embodiments, the vehicle 144 is capable operating in at least a partially autonomous control mode. In some embodiments, the vehicle 144 can be a fully autonomous vehicle. In some embodiments, the vehicle 144 can operate as a Level 3 or Level 4 vehicle as defined by the National Highway Traffic Safety Administration (“NHTSA”). The NHTSA defines a Level 3 vehicle as a limited self-driving automation vehicle that enables a driver to cede full control of all safety-critical functions under certain traffic or environmental conditions and in those conditions to rely heavily on the vehicle to monitor for changes in those conditions requiring transition back to driver control. The driver is expected to be available for occasional control, but with sufficiently comfortable transition time. The GOOGLE car, available from GOOGLE LLC, is an example of a limited self-driving automation vehicle. The NHTSA defines a Level 4 vehicle as a full self-driving automation vehicle that is designed to perform all safety-critical driving functions and monitor roadway conditions for an entire trip to a destination. Such a design anticipates that the driver will provide destination or navigation input, but is not expected to be available for control at any time during the trip.

Although not shown in the illustrated example, the vehicle 144 can include one or more vehicle systems such as, for example, an on-board diagnostics (“OBD”) system, a hands-free telephone system, a vehicle entertainment system (also commonly referred to as “an infotainment system”), a vehicle navigation system, a global positioning system (“GPS”), a vehicle engine control unit (“ECU”), and/or another system associated with the vehicle 144. The vehicle system(s) may be retrofitted into the vehicle 144 as aftermarket equipment or may be made available as standard or optional original equipment manufacturer (“OEM”) equipment of the vehicle 144.

The service provider can be a telecommunications service provider that provides landline telephone service, Internet service, and/or other telecommunications services. The service provider can be a television service provider that provides cable, satellite, IP, and/or other television services. Utility service providers such as power companies, water companies, sewage companies, and the like are also contemplated. It should be understood that the concepts and technologies disclosed herein can be applied to any service type provided by any service provider where the technician 106 must travel to the customer location 112 from the technician starting location 134. As such, the examples provided herein should not be construed as being limiting in any way.

The map module 118 can be standalone mapping software or an application programming interface (“API”) that can call mapping software available elsewhere via the network 128. In some embodiments, the map module 118 utilizes GOOGLE MAPS API (available from GOOGLE LLC). The map module 118 can utilize geographical data sourced from a geographic information system (“GIS”) and/or like system(s). The map module 118 can provide visualizations of one or more maps to enable the system engineers 132 to view the geographical area 108 and the territories 104 thereof. The map module 118 can provide functionality to allow the system engineers 132 to interact with the maps created by the map module 118. For example, the map module 118 can enable zoom in/out functions, pan functions, searching functions, and the like. Those skilled in the art will appreciate the numerous mapping software available. The map module 118 therefore should not be construed as being limited to any particular mapping software.

The data clustering algorithm module 120 can receive, as input, job data 146 that can identify a plurality of jobs at the customer locations 112 throughout the geographical area 108. The job data 146 can include historical job data for jobs completed within a specific time period (e.g., 20 days). The system engineers 132 can manipulate the time period as needed. The job data 146 can be sourced from one or more databases (not shown), such as those utilized by the service provider to track jobs for the technicians 106. The data clustering algorithm module 120 can receive one or more clustering parameters 148 and output job dense areas, which preliminarily are the territories to be assigned to the technicians 106. The clustering parameters 148 can include a distance measurement and a number of points. The distance measurement can identify a distance (e.g., in miles or kilometers) from a specific location (e.g., one of the customer locations 112, one of the technician starting locations 134, or some other location). The number of points can identify the number of other jobs that should be within the distance measurement. For example, 300 jobs over a period of 20 days within 5 miles of the starting location may work well for certain implementations. In some embodiments, the data clustering algorithm module 120 is or utilizes a density-based clustering algorithm such as density-based spatial clustering of applications with noise (“DBSCAN”). DBSCAN is well-known in the art and well-suited for performing data clustering for the territory assignment optimization system 102. It should be understood, however, that the data clustering algorithm module 120 other well-known clustering algorithms and/or proprietary data clustering algorithms. As such, the specific implementation of the data clustering algorithm module 120 using DBSCAN should not be construed as being limiting in any way.

The Gaussian mixture clustering algorithm module 122 can utilize a Gaussian mixture model to ensure that none of the territories 104 are too geographically large for the technicians 106 to effectively and efficiently service. The clustering parameters 148 can additionally include a maximum size for the territories 104. For example, a maximum size of 150 miles on the diagonal of the smallest bounding rectangle may be used to ensure that no territory 104 greater than 150 miles on the diagonal of the smallest bounding rectangle may be used. Although the Gaussian mixture model is specifically described herein, other data clustering models are contemplated, such as k-means.

The local search-based optimization algorithm module 124 can exchange the territory 104 of an area that is on the boundary between two territories 104 if the exchange improves either: (1) The balance of jobs and technicians 106 in the territory 104 (e.g., 2 jobs per service technician per day, although this can be customized as needed); or (2) The distance between a job and the nearest technician 106 in the assigned territory 104.

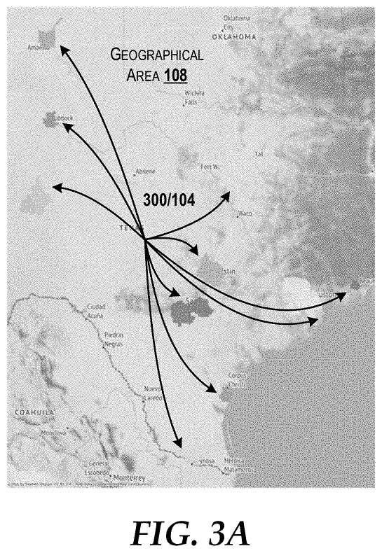

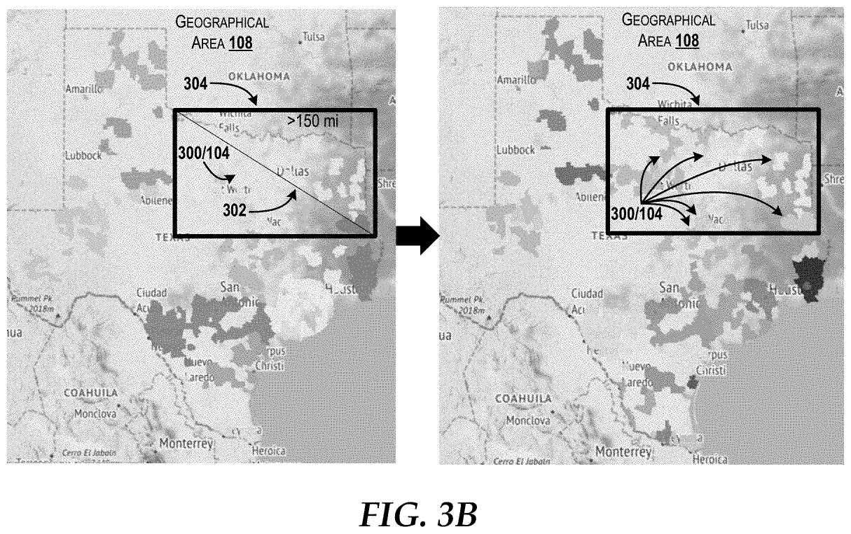

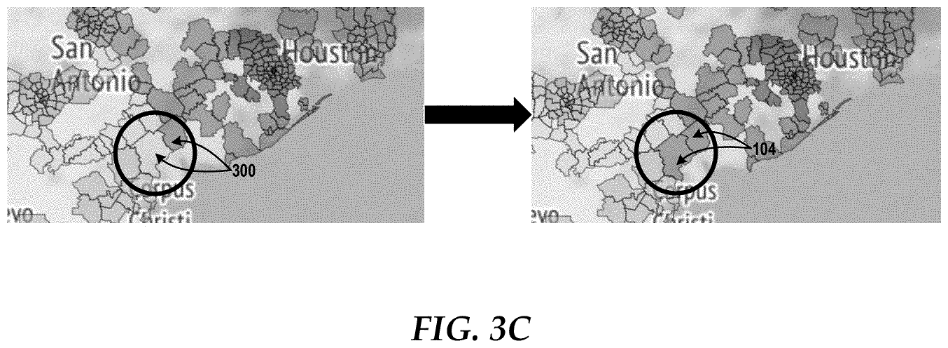

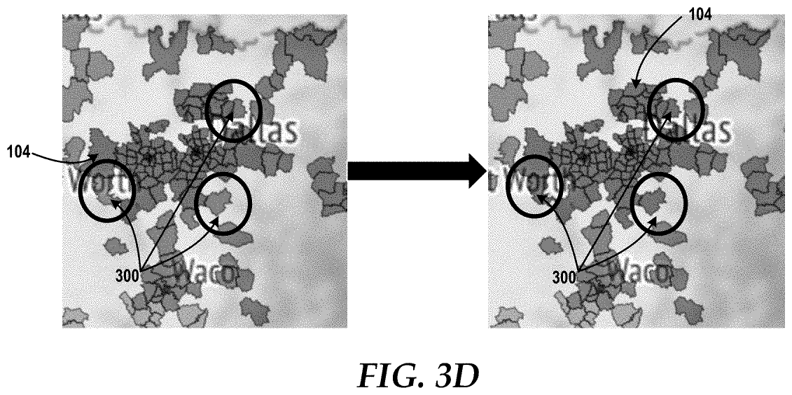

The sanity check module 126 can receive one or more constraints 150 that the system engineer 132 would like to use for a specific implementation. Application of the constraints 150 can serve as a sanity check for the results of the territory assignment optimization. For example, a customer location 112 can be assigned to a different territory 104 if all neighbors of the customer location 112 are in the different territory. An example of this is best shown in FIG. 3D.

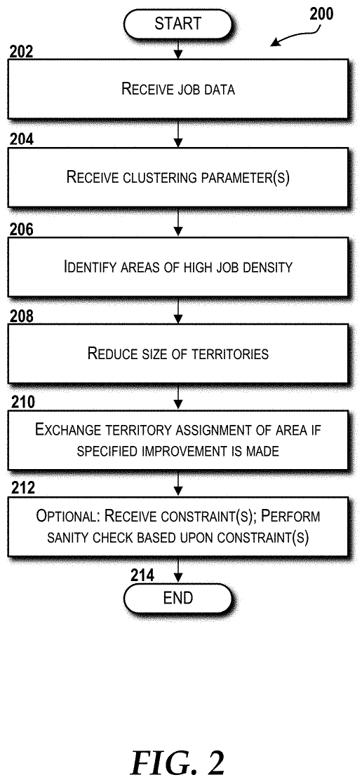

Turning now to FIG. 2, a flow diagram illustrating aspects of a method 200 for optimally assigning the territories 104 to the technicians 106 will be described, according to an illustrative embodiment. It should be understood that the operations of the method disclosed herein is not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the method disclosed herein can be ended at any time and need not be performed in its entirety. Some or all operations of the method, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, or a portion thereof, to perform one or more operations, and/or causing the processor to direct other components of the computing system or device to perform one or more of the operations.

For purposes of illustrating and describing the concepts of the present disclosure, operations of the method disclosed herein are described as being performed alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 200 begins and proceeds to operation 202. The method 200 will be described from the perspective of the territory assignment optimization system 102 executing the various modules described herein above with reference to FIG. 1. The territory assignment optimization system 102 can be implemented as a computer system 400 such as described herein with reference to FIG. 4, and as such, can execute the modules described herein above via one or more processing units 402 (best shown in FIG. 4). Alternatively, the territory assignment optimization system 102 can be implemented on a virtualized cloud architecture 600 such as described herein with reference to FIG. 6, and as such, can execute the modules described herein above via one or more compute resources 610 or virtualizations thereof (best shown in FIG. 6). These example implementations are merely exemplary and should not be construed as being limiting in any way. The method 200 will also be described with additional reference to FIGS. 3A-3D.

At operation 202, the territory assignment optimization system 102 receives, as input, the job data 146 that can identify a plurality of jobs at the customer locations 112 throughout the geographical area 108. From operation 202, the method 200 proceeds to operation 204. At operation 204, the territory assignment optimization system 102 receives the clustering parameters 148. The clustering parameters 148 can include a distance measurement and a number of points. The distance measurement can identify a distance (e.g., in miles or kilometers) from a specific location (e.g., one of the customer locations 112, one of the technician starting locations 134, or some other location). The number of points can identify the number of other jobs that should be within the distance measurement. For example, 300 jobs over a period of 20 days within 5 miles of the starting location may work well for certain implementations. The clustering parameters 148 can additionally include a maximum size for the territories 104.

From operation 204, the method 200 proceeds to operation 206. At operation 206, the territory assignment optimization system 102 executes the data clustering algorithm module 120 to identify areas of high job density (best shown as job dense areas 300 in FIG. 3A) within the geographical area 108 based upon the distance measurement and the number of points obtained from the clustering parameters 148. The job dense areas 300 are preliminarily the territories 104 to be assigned to the technicians 106. The remaining operations of the method 200 optimize the territories 104.

From operation 206, the method 200 proceeds to operation 208. At operation 208, the territory assignment optimization system 102 can execute the Gaussian mixture clustering algorithm module 122 to reduce the size of the territories 104 (job dense areas 300) based upon the maximum size obtained from the clustering parameters 148. For example, as shown in FIG. 3B, a maximum size of 150 miles on a diagonal 302 of a smallest bounding rectangle 304 may be used to ensure that no territory 104 greater than 150 miles on the diagonal 302 of the smallest bounding rectangle 304 may be used.

From operation 208, the method 200 proceeds to operation 210. At operation 210, the territory assignment optimization system 102 can execute the local search-based optimization algorithm module 124 to exchange the territory 104 to which a job dense area 300 is assigned if the exchange improves either: (1) The balance of jobs and technicians 106 in the territory 104 (e.g., 2 jobs per service technician per day, although this can be customized as needed); or (2) The distance between a job and the nearest technician 106 in the assigned territory 104. The local search-based optimization algorithm module 124 can utilize two scoring functions. One scoring function can be used to evaluate the sum of the distances between all jobs and the nearest technician starting location 134. Another scoring function can be used to evaluate how close each of the territories 104 is to X jobs per technician 106, where X can be defined by the system engineer 132. In FIG. 3C, two differently shaded/colored job dense areas 300 are shown before the local search-based optimization algorithm module 124 is executed. After the local search-based optimization algorithm module 124 is executed, the job dense areas 300 are assigned to the same territory 104.

From operation 210, the method 200 proceeds to optional operation 212. At operation 212, the territory assignment optimization system 102 can receive the constraint(s) 150. The constraint(s) 150 can be customized for the needs of a given implementation. By way of example, and not limitation, a constraint 150 may cause a job dense area 300 to be assigned to a different territory 104 if all neighbors of the job dense area 300 are in the different territory 104. An example of this is best shown in FIG. 3D in which the job dense areas 300 each have all neighbors that belong to the different territory 104, and accordingly can be reassigned as shown. Also at operation 212, the territory assignment optimization system 102 can execute the sanity check module 126 to perform one or more sanity checks based upon the constraints 150. In the example above, execution of the sanity check module 126 can determine whether any of the job dense areas 300 should be assigned to a different territory based upon the territory 104 to which all neighbors are assigned.

From operation 212, the method 200 proceeds to operation 214. At operation 214, the method 200 can end.

Turning now to FIG. 4, a block diagram illustrating a computer system 400 configured to provide the functionality described herein in accordance with various embodiments. In some embodiments, the territory assignment optimization system 102 is configured the same as or similar to the computer system 400. In some embodiments, the technician distribution system 140 is configured the same as or similar to the computer system 400. In some embodiments, the technician device(s) 142 is/are configured the same as or similar to the computer system 400. The computer system 400 includes a processing unit 402, a memory 404, one or more user interface devices 406, one or more input/output (“I/O”) devices 408, and one or more network devices 410, each of which is operatively connected to a system bus 412. The bus 412 enables bi-directional communication between the processing unit 402, the memory 404, the user interface devices 406, the I/O devices 408, and the network devices 410.

The processing unit 402 may be a standard central processor that performs arithmetic and logical operations, a more specific purpose programmable logic controller (“PLC”), a programmable gate array, or other type of processor known to those skilled in the art and suitable for controlling the operation of the server computer. The processing unit 402 can be a single processing unit or a multiple processing unit that includes more than one processing component. Processing units are generally known, and therefore are not described in further detail herein.

The memory 404 communicates with the processing unit 402 via the system bus 412. The memory 404 can include a single memory component or multiple memory components. In some embodiments, the memory 404 is operatively connected to a memory controller (not shown) that enables communication with the processing unit 402 via the system bus 412. The memory 404 includes an operating system 414 and one or more program modules 416. The operating system 414 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OSX, iOS, and/or families of operating systems from APPLE CORPORATION, the FREEBSD family of operating systems, the SOLARIS family of operating systems from ORACLE CORPORATION, other operating systems, and the like.

The program modules 416 may include various software and/or program modules described herein. The program modules 416 can include the map module 118, the data clustering algorithm module 120, the Gaussian mixture clustering algorithm module 122, the local search-based optimization algorithm module 124, and the sanity check module 126. In some embodiments, multiple implementations of the computer system 400 can be used, wherein each implementation is configured to execute one or more of the program modules 416. The program modules 416 and/or other programs can be embodied in computer-readable media containing instructions that, when executed by the processing unit 402, perform the method 200 described herein. According to embodiments, the program modules 416 may be embodied in hardware, software, firmware, or any combination thereof. The memory 404 also can be configured to store the input parameters 130, including the job data 146, the clustering parameters 148, and the constraints 150, and/or other data disclosed herein.

By way of example, and not limitation, computer-readable media may include any available computer storage media or communication media that can be accessed by the computer system 400. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 400. In the claims, the phrase “computer storage medium,” “computer-readable storage medium,” and variations thereof does not include waves or signals per se and/or communication media, and therefore should be construed as being directed to “non-transitory” media only.

The user interface devices 406 may include one or more devices with which a user accesses the computer system 400. The user interface devices 406 may include, but are not limited to, computers, servers, personal digital assistants, cellular phones, or any suitable computing devices. The I/O devices 408 enable a user to interface with the program modules 416. In one embodiment, the I/O devices 408 are operatively connected to an I/O controller (not shown) that enables communication with the processing unit 402 via the system bus 412. The I/O devices 408 may include one or more input devices, such as, but not limited to, a keyboard, a mouse, or an electronic stylus. Further, the I/O devices 408 may include one or more output devices, such as, but not limited to, a display screen or a printer.

The network devices 410 enable the computer system 400 to communicate with other networks or remote systems via the network(s) 128. Examples of the network devices 410 include, but are not limited to, a modem, a radio frequency (“RF”) or infrared (“IR”) transceiver, a telephonic interface, a bridge, a router, or a network card. The network 128 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 128 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

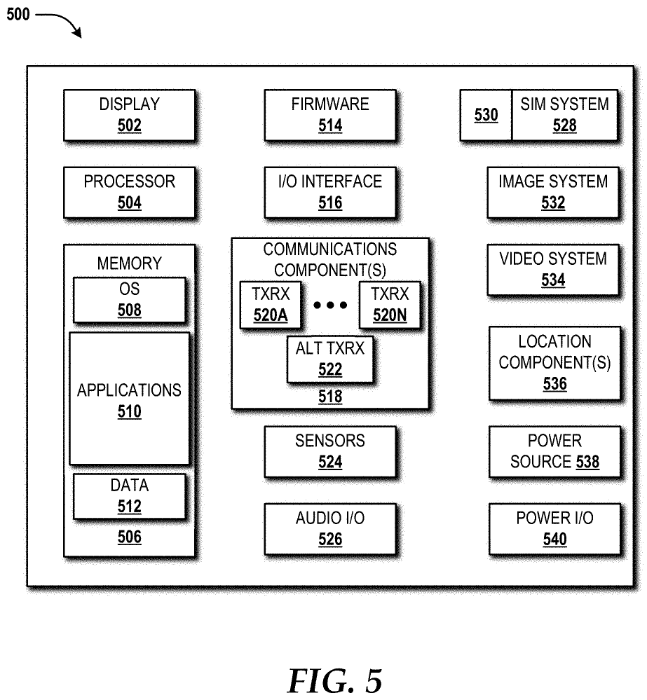

Turning now to FIG. 5, an illustrative mobile device 500 and components thereof will be described. In some embodiments, the technician device(s) 142 is/are configured similar to or the same as the mobile device 500. While connections are not shown between the various components illustrated in FIG. 5, it should be understood that some, none, or all of the components illustrated in FIG. 5 can be configured to interact with one another to carry out various device functions. In some embodiments, the components are arranged so as to communicate via one or more busses (not shown). Thus, it should be understood that FIG. 5 and the following description are intended to provide a general understanding of a suitable environment in which various aspects of embodiments can be implemented, and should not be construed as being limiting in any way.

As illustrated in FIG. 5, the mobile device 500 can include a display 502 for displaying data. According to various embodiments, the display 502 can be configured to display various GUI elements, text, images, video, virtual keypads and/or keyboards, messaging data, notification messages, metadata, Internet content, device status, time, date, calendar data, device preferences, map and location data, combinations thereof, and/or the like. The mobile device 500 also can include a processor 504 and a memory or other data storage device (“memory”) 506. The processor 504 can be configured to process data and/or can execute computer-executable instructions stored in the memory 506. The computer-executable instructions executed by the processor 504 can include, for example, an operating system 508, one or more applications 510, other computer-executable instructions stored in the memory 506, or the like. In some embodiments, the applications 510 also can include a UI application (not illustrated in FIG. 5).

The UI application can interface with the operating system 508 to facilitate user interaction with functionality and/or data stored at the mobile device 500 and/or stored elsewhere. In some embodiments, the operating system 508 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE LLC, and/or other operating systems. These operating systems are merely illustrative of some contemplated operating systems that may be used in accordance with various embodiments of the concepts and technologies described herein and therefore should not be construed as being limiting in any way.

The UI application can be executed by the processor 504 to aid a user in entering/deleting data, entering and setting user IDs and passwords for device access, configuring settings, manipulating content and/or settings, multimode interaction, interacting with other applications 510, and otherwise facilitating user interaction with the operating system 508, the applications 510, and/or other types or instances of data 512 that can be stored at the mobile device 500.

The applications 510, the data 512, and/or portions thereof can be stored in the memory 506 and/or in a firmware 514, and can be executed by the processor 504. The firmware 514 also can store code for execution during device power up and power down operations. It can be appreciated that the firmware 514 can be stored in a volatile or non-volatile data storage device including, but not limited to, the memory 506 and/or a portion thereof.

The mobile device 500 also can include an input/output (“I/O”) interface 516. The I/O interface 516 can be configured to support the input/output of data such as location information, presence status information, user IDs, passwords, and application initiation (start-up) requests. In some embodiments, the I/O interface 516 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 500 can be configured to synchronize with another device to transfer content to and/or from the mobile device 500. In some embodiments, the mobile device 500 can be configured to receive updates to one or more of the applications 510 via the I/O interface 516, though this is not necessarily the case. In some embodiments, the I/O interface 516 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 516 may be used for communications between the mobile device 500 and a network device or local device.

The mobile device 500 also can include a communications component 518. The communications component 518 can be configured to interface with the processor 504 to facilitate wired and/or wireless communications with one or more networks, such as the network 128, the Internet, or some combination thereof. In some embodiments, the communications component 518 includes a multimode communications subsystem for facilitating communications via the cellular network and one or more other networks.

The communications component 518, in some embodiments, includes one or more transceivers. The one or more transceivers, if included, can be configured to communicate over the same and/or different wireless technology standards with respect to one another. For example, in some embodiments, one or more of the transceivers of the communications component 518 may be configured to communicate using Global System for Mobile communications (“GSM”), Code-Division Multiple Access (“CDMA”) CDMAONE, CDMA2000, Long-Term Evolution (“LTE”) LTE, and various other 2G, 2.5G, 3G, 4G, 4.5G, 5G, and greater generation technology standards. Moreover, the communications component 518 may facilitate communications over various channel access methods (which may or may not be used by the aforementioned standards) including, but not limited to, Time-Division Multiple Access (“TDMA”), Frequency-Division Multiple Access (“FDMA”), Wideband CDMA (“W-CDMA”), Orthogonal Frequency-Division Multiple Access (“OFDMA”), Space-Division Multiple Access (“SDMA”), and the like.

In addition, the communications component 518 may facilitate data communications using General Packet Radio Service (“GPRS”), Enhanced Data services for Global Evolution (“EDGE”), the High-Speed Packet Access (“HSPA”) protocol family including High-Speed Downlink Packet Access (“HSDPA”), Enhanced Uplink (“EUL”) (also referred to as High-Speed Uplink Packet Access (“HSUPA”), HSPA+, and various other current and future wireless data access standards. In the illustrated embodiment, the communications component 518 can include a first transceiver (“TxRx”) 520A that can operate in a first communications mode (e.g., GSM). The communications component 518 also can include an N^{th} transceiver (“TxRx”) 520N that can operate in a second communications mode relative to the first transceiver 520A (e.g., UMTS). While two transceivers 520A-520N (hereinafter collectively and/or generically referred to as “transceivers 520”) are shown in FIG. 5, it should be appreciated that less than two, two, and/or more than two transceivers 520 can be included in the communications component 518.

The communications component 518 also can include an alternative transceiver (“Alt TxRx”) 522 for supporting other types and/or standards of communications. According to various contemplated embodiments, the alternative transceiver 522 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 518 also can facilitate reception from terrestrial radio networks, digital satellite radio networks, internet-based radio service networks, combinations thereof, and the like. The communications component 518 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 500 also can include one or more sensors 524. The sensors 524 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 500 may be provided by an audio I/O component 526. The audio I/O component 526 of the mobile device 500 can include one or more speakers for the output of audio signals, one or more microphones for the collection and/or input of audio signals, and/or other audio input and/or output devices.

The illustrated mobile device 500 also can include a subscriber identity module (“SIM”) system 528. The SIM system 528 can include a universal SIM (“USIM”), a universal integrated circuit card (“UICC”) and/or other identity devices. The SIM system 528 can include and/or can be connected to or inserted into an interface such as a slot interface 530. In some embodiments, the slot interface 530 can be configured to accept insertion of other identity cards or modules for accessing various types of networks. Additionally, or alternatively, the slot interface 530 can be configured to accept multiple subscriber identity cards. Because other devices and/or modules for identifying users and/or the mobile device 500 are contemplated, it should be understood that these embodiments are illustrative, and should not be construed as being limiting in any way.

The mobile device 500 also can include an image capture and processing system 532 (“image system”). The image system 532 can be configured to capture or otherwise obtain photos, videos, and/or other visual information. As such, the image system 532 can include cameras, lenses, charge-coupled devices (“CCDs”), combinations thereof, or the like. The mobile device 500 may also include a video system 534. The video system 534 can be configured to capture, process, record, modify, and/or store video content. Photos and videos obtained using the image system 532 and the video system 534, respectively, may be added as message content to an MMS message, email message, and sent to another device. The video and/or photo content also can be shared with other devices via various types of data transfers via wired and/or wireless communication devices as described herein.

The mobile device 500 also can include one or more location components 536. The location components 536 can be configured to send and/or receive signals to determine a geographic location of the mobile device 500. According to various embodiments, the location components 536 can send and/or receive signals from global positioning system (“GPS”) devices, assisted-GPS (“A-GPS”) devices, WI-FI/WIMAX and/or cellular network triangulation data, combinations thereof, and the like. The location component 536 also can be configured to communicate with the communications component 518 to retrieve triangulation data for determining a location of the mobile device 500. In some embodiments, the location component 536 can interface with cellular network nodes, telephone lines, satellites, location transmitters and/or beacons, wireless network transmitters and receivers, combinations thereof, and the like. In some embodiments, the location component 536 can include and/or can communicate with one or more of the sensors 524 such as a compass, an accelerometer, and/or a gyroscope to determine the orientation of the mobile device 500. Using the location component 536, the mobile device 500 can generate and/or receive data to identify its geographic location, or to transmit data used by other devices to determine the location of the mobile device 500. The location component 536 may include multiple components for determining the location and/or orientation of the mobile device 500.

The illustrated mobile device 500 also can include a power source 538. The power source 538 can include one or more batteries, power supplies, power cells, and/or other power subsystems including alternating current (“AC”) and/or direct current (“DC”) power devices. The power source 538 also can interface with an external power system or charging equipment via a power I/O component 540. Because the mobile device 500 can include additional and/or alternative components, the above embodiment should be understood as being illustrative of one possible operating environment for various embodiments of the concepts and technologies described herein. The described embodiment of the mobile device 500 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 500 or other devices or computers described herein, such as the computer system 400 described above with reference to FIG. 4. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 500 in order to store and execute the software components presented herein. It is also contemplated that the mobile device 500 may not include all of the components shown in FIG. 5, may include other components that are not explicitly shown in FIG. 5, or may utilize an architecture completely different than that shown in FIG. 5.

Turning now to FIG. 6, a block diagram illustrating an example virtualized cloud architecture 600 and components thereof will be described, according to an exemplary embodiment. In some embodiments, the virtualized cloud architecture 600 can be utilized to implement, at least in part, the territory assignment optimization system 102, the technician distribution system 140, the technician device(s) 142, and/or the network(s) 128 or a portion thereof. The virtualized cloud architecture 600 is a shared infrastructure that can support multiple services and network applications. The illustrated virtualized cloud architecture 600 includes a hardware resource layer 602, a control layer 604, a virtual resource layer 606, and an application layer 608 that work together to perform operations as will be described in detail herein.

The hardware resource layer 602 provides hardware resources, which, in the illustrated embodiment, include one or more compute resources 610, one or more memory resources 612, and one or more other resources 614. The compute resource(s) 610 can include one or more hardware components that perform computations to process data, and/or to execute computer-executable instructions of one or more application programs, operating systems, and/or other software. The compute resources 610 can include one or more central processing units (“CPUs”) configured with one or more processing cores. The compute resources 610 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources 610 can include one or more discrete GPUs. In some other embodiments, the compute resources 610 can include CPU and GPU components that are configured in accordance with a co-processing CPU/GPU computing model, wherein the sequential part of an application executes on the CPU and the computationally-intensive part is accelerated by the GPU. The compute resources 610 can include one or more system-on-chip (“SoC”) components along with one or more other components, including, for example, one or more of the memory resources 612, and/or one or more of the other resources 614. In some embodiments, the compute resources 610 can be or can include one or more SNAPDRAGON SoCs, available from QUALCOMM; one or more TEGRA SoCs, available from NVIDIA; one or more HUMMINGBIRD SoCs, available from SAMSUNG; one or more Open Multimedia Application Platform (“OMAP”) SoCs, available from TEXAS INSTRUMENTS; one or more customized versions of any of the above SoCs; and/or one or more proprietary SoCs. The compute resources 610 can be or can include one or more hardware components architected in accordance with an advanced reduced instruction set computing (“RISC”) machine (“ARM”) architecture, available for license from ARM HOLDINGS. Alternatively, the compute resources 610 can be or can include one or more hardware components architected in accordance with an x86 architecture, such an architecture available from INTEL CORPORATION of Mountain View, Calif., and others. Those skilled in the art will appreciate the implementation of the compute resources 610 can utilize various computation architectures, and as such, the compute resources 610 should not be construed as being limited to any particular computation architecture or combination of computation architectures, including those explicitly disclosed herein.

The memory resource(s) 612 can include one or more hardware components that perform storage operations, including temporary or permanent storage operations. In some embodiments, the memory resource(s) 612 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 610.

The other resource(s) 614 can include any other hardware resources that can be utilized by the compute resources(s) 610 and/or the memory resource(s) 612 to perform operations described herein. The other resource(s) 614 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 602 can be virtualized by one or more virtual machine monitors (“VMMs”) 616A-616N (also known as “hypervisors”; hereinafter “VMMs 616”) operating within the control layer 604 to manage one or more virtual resources that reside in the virtual resource layer 606. The VMMs 616 can be or can include software, firmware, and/or hardware that alone or in combination with other software, firmware, and/or hardware, manages one or more virtual resources operating within the virtual resource layer 606.

The virtual resources operating within the virtual resource layer 606 can include abstractions of at least a portion of the compute resources 610, the memory resources 612, the other resources 614, or any combination thereof. These abstractions are referred to herein as virtual machines (“VMs”). In the illustrated embodiment, the virtual resource layer 606 includes VMs 618A-618N (hereinafter “VMs 618”). Each of the VMs 618 can execute one or more applications 620A-620N in the application layer 608.

Turning now to FIG. 7, details of the network 128 are illustrated, according to an illustrative embodiment. The network 128 includes a cellular network 702, a packet data network 704, and a circuit switched network 706 (e.g., a public switched telephone network). The cellular network 702 includes various components such as, but not limited to, base transceiver stations (“BTSs”), Node-Bs or e-Node-Bs, base station controllers (“BSCs”), radio network controllers (“RNCs”), mobile switching centers (“MSCs”), mobility management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, and the like. The cellular network 702 also includes radios and nodes for receiving and transmitting voice, data, and combinations thereof to and from radio transceivers, networks, the packet data network 704, and the circuit switched network 706.

A mobile communications device 708, such as, for example, the technician device(s) 142, a cellular telephone, a user equipment, a mobile terminal, a PDA, a laptop computer, a handheld computer, and combinations thereof, can be operatively connected to the cellular network 702. The mobile communications device 708 can be configured similar to or the same as the mobile device 500 described above with reference to FIG. 5.

The cellular network 702 can be configured as a GSM network and can provide data communications via GPRS and/or EDGE. Additionally, or alternatively, the cellular network 702 can be configured as a 3G Universal Mobile Telecommunications System (“UMTS”) network and can provide data communications via the HSPA protocol family, for example, HSDPA, EUL, and HSPA+. The cellular network 702 also is compatible with mobile communications standards such as LTE, or the like, as well as evolved and future mobile standards.

The packet data network 704 includes various systems, devices, servers, computers, databases, and other devices in communication with one another, as is generally known. In some embodiments, the packet data network 704 is or includes one or more WI-FI networks, each of which can include one or more WI-FI access points, routers, switches, and other WI-FI network components. The packet data network 704 devices are accessible via one or more network links. The servers often store various files that are provided to a requesting device such as, for example, a computer, a terminal, a smartphone, or the like. Typically, the requesting device includes software for executing a web page in a format readable by the browser or other software. Other files and/or data may be accessible via “links” in the retrieved files, as is generally known. In some embodiments, the packet data network 704 includes or is in communication with the Internet. The circuit switched network 706 includes various hardware and software for providing circuit switched communications. The circuit switched network 706 may include, or may be, what is often referred to as a plain old telephone system (“POTS”). The functionality of a circuit switched network 706 or other circuit-switched network are generally known and will not be described herein in detail.

The illustrated cellular network 702 is shown in communication with the packet data network 704 and a circuit switched network 706, though it should be appreciated that this is not necessarily the case. One or more Internet-capable systems/devices 710 such as the territory assignment optimization system 102, the technician distribution system 140, the technician devices 142, a laptop, a portable device, or another suitable device, can communicate with one or more cellular networks 702, and devices connected thereto, through the packet data network 704. It also should be appreciated that the Internet-capable device 710 can communicate with the packet data network 704 through the circuit switched network 706, the cellular network 702, and/or via other networks (not illustrated).

As illustrated, a communications device 712, for example, a telephone, facsimile machine, modem, computer, or the like, can be in communication with the circuit switched network 706, and therethrough to the packet data network 704 and/or the cellular network 702. It should be appreciated that the communications device 712 can be an Internet-capable device, and can be substantially similar to the Internet-capable device 710.

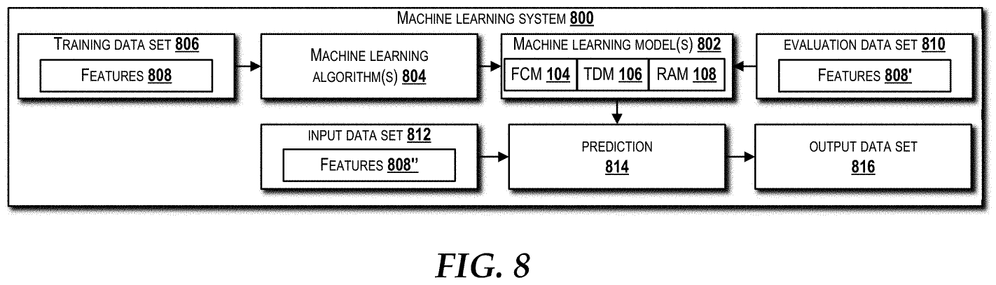

Turning now to FIG. 8, a machine learning system 800 capable of implementing aspects of the embodiments disclosed herein will be described. In some embodiments, aspects of the territory assignment optimization system 102 can be improved via machine learning. Accordingly, the territory assignment optimization system 102 can include the machine learning system 800 or can be in communication with the machine learning system 800.

The illustrated machine learning system 800 includes one or more machine learning models 802. The machine learning models 802 can include, unsupervised, supervised, and/or semi-supervised learning models. The machine learning model(s) 802 can be created by the machine learning system 800 based upon one or more machine learning algorithms 804. The machine learning algorithm(s) 804 can be any existing, well-known algorithm, any proprietary algorithms, or any future machine learning algorithm. Some example machine learning algorithms 804 include, but are not limited to, neural networks, gradient descent, linear regression, logistic regression, linear discriminant analysis, classification tree, regression tree, Naive Bayes, K-nearest neighbor, learning vector quantization, support vector machines, any of the algorithms described herein, and the like. Classification and regression algorithms might find particular applicability to the concepts and technologies disclosed herein. Those skilled in the art will appreciate the applicability of various machine learning algorithms 804 based upon the problem(s) to be solved by machine learning via the machine learning system 800.

The machine learning system 800 can control the creation of the machine learning models 802 via one or more training parameters. In some embodiments, the training parameters are selected modelers at the direction of an enterprise, for example. Alternatively, in some embodiments, the training parameters are automatically selected based upon data provided in one or more training data sets 806. The training parameters can include, for example, a learning rate, a model size, a number of training passes, data shuffling, regularization, and/or other training parameters known to those skilled in the art.

The learning rate is a training parameter defined by a constant value. The learning rate affects the speed at which the machine learning algorithm 804 converges to the optimal weights. The machine learning algorithm 804 can update the weights for every data example included in the training data set 806. The size of an update is controlled by the learning rate. A learning rate that is too high might prevent the machine learning algorithm 804 from converging to the optimal weights. A learning rate that is too low might result in the machine learning algorithm 804 requiring multiple training passes to converge to the optimal weights.

The model size is regulated by the number of input features (“features”) 808 in the training data set 806. A greater the number of features 808 yields a greater number of possible patterns that can be determined from the training data set 806. The model size should be selected to balance the resources (e.g., compute, memory, storage, etc.) needed for training and the predictive power of the resultant machine learning model 802.

The number of training passes indicates the number of training passes that the machine learning algorithm 804 makes over the training data set 806 during the training process. The number of training passes can be adjusted based, for example, on the size of the training data set 806, with larger training data sets being exposed to fewer training passes in consideration of time and/or resource utilization. The effectiveness of the resultant machine learning model 802 can be increased by multiple training passes.

Data shuffling is a training parameter designed to prevent the machine learning algorithm 804 from reaching false optimal weights due to the order in which data contained in the training data set 806 is processed. For example, data provided in rows and columns might be analyzed first row, second row, third row, etc., and thus an optimal weight might be obtained well before a full range of data has been considered. By data shuffling, the data contained in the training data set 806 can be analyzed more thoroughly and mitigate bias in the resultant machine learning model 802.

Regularization is a training parameter that helps to prevent the machine learning model 802 from memorizing training data from the training data set 806. In other words, the machine learning model 802 fits the training data set 806, but the predictive performance of the machine learning model 802 is not acceptable. Regularization helps the machine learning system 800 avoid this overfitting/memorization problem by adjusting extreme weight values of the features 808. For example, a feature that has a small weight value relative to the weight values of the other features in the training data set 806 can be adjusted to zero.

The machine learning system 800 can determine model accuracy after training by using one or more evaluation data sets 810 containing the same features 808′ as the features 808 in the training data set 806. This also prevents the machine learning model 802 from simply memorizing the data contained in the training data set 806. The number of evaluation passes made by the machine learning system 800 can be regulated by a target model accuracy that, when reached, ends the evaluation process and the machine learning model 802 is considered ready for deployment.

After deployment, the machine learning model 802 can perform a prediction operation (“prediction”) 814 with an input data set 812 having the same features 808″ as the features 808 in the training data set 806 and the features 808′ of the evaluation data set 810. The results of the prediction 814 are included in an output data set 816 consisting of predicted data. The machine learning model 802 can perform other operations, such as regression, classification, and others. As such, the example illustrated in FIG. 8 should not be construed as being limiting in any way.

Based on the foregoing, it should be appreciated that aspects of territory assignment optimization have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
receiving, by a territory assignment optimization system comprising a processor, job data that identifies a plurality of jobs at a plurality of customer locations throughout a geographical area;
receiving, by the territory assignment optimization system, clustering parameters;
identifying, via execution of a data clustering algorithm by the processor of the territory assignment optimization system, a plurality of job dense areas within the geographical area based upon the job data and the clustering parameters;
reducing, by the territory assignment optimization system, a size of at least one territory of a plurality of territories, wherein each territory of the plurality of territories comprises a portion of the plurality of job dense areas; and
conditionally exchanging, by the territory assignment optimization system, an assignment of at least one of the plurality of job dense areas from a first territory of the plurality of territories to a second territory of the plurality of territories.

2. The method of claim 1, wherein:
the clustering parameters comprise a distance measurement and a number of points;
the distance measurement identifies a distance from a specific location; and
the number of points identify a number of other jobs that should be within the distance from the specific location.

3. The method of claim 2, wherein the specific location comprises a technician starting location.

4. The method of claim 2, wherein the data clustering algorithm comprises a density-based spectral clustering of applications with noise (“DBSCAN”) algorithm.

5. The method of claim 2, wherein the clustering parameters further comprise a maximum size; and wherein reducing, by the territory assignment optimization system, the size of at least one territory comprises reducing, by the territory assignment optimization system, the size of at least one territory based upon the maximum size.

6. The method of claim 5, wherein reducing, by the territory assignment optimization system, the size of at least one territory based upon the maximum size comprises reducing, via execution of a Gaussian mixture clustering algorithm by the processor of the territory assignment optimization system, the size of at least one territory based upon the maximum size.

7. The method of claim 6, wherein conditionally exchanging the assignment of at least one of the plurality of job dense areas from the first territory of the plurality of territories to the second territory of the plurality of territories comprises exchanging the assignment of at least one of the plurality of job dense areas from the first territory of the plurality of territories to the second territory of the plurality of territories to improve a balance of a number of jobs to a number of technicians among the first territory and the second territory.

8. The method of claim 6, wherein conditionally exchanging the assignment of at least one of the plurality of job dense areas from the first territory of the plurality of territories to the second territory of the plurality of territories comprises exchanging the assignment of at least one of the plurality of job dense areas from the first territory of the plurality of territories to the second territory of the plurality of territories to improve a distance between at least one job of the plurality of jobs and a nearest technician.

9. A computer-readable storage medium comprising computer-executable instructions that, when executed by a processor of a territory assignment optimization system, cause the processor to perform operations comprising:
receiving job data that identifies a plurality of jobs at a plurality of customer locations throughout a geographical area;
receiving clustering parameters;
identifying, via execution of a data clustering algorithm, a plurality of job dense areas within the geographical area based upon the job data and the clustering parameters;
reducing a size of at least one territory of a plurality of territories, wherein each territory of the plurality of territories comprises a portion of the plurality of job dense areas; and
conditionally exchanging an assignment of at least one of the plurality of job dense areas from a first territory of the plurality of territories to a second territory of the plurality of territories.

10. The computer-readable storage medium of claim 9, wherein:
the clustering parameters comprise a distance measurement and a number of points;
the distance measurement identifies a distance from a specific location; and
the number of points identify a number of other jobs that should be within the distance from the specific location.

11. The computer-readable storage medium of claim 10, wherein the specific location comprises a technician starting location.

12. The computer-readable storage medium of claim 10, wherein the data clustering algorithm comprises a density-based spectral clustering of applications with noise (“DBSCAN”) algorithm.

13. The computer-readable storage medium of claim 10, wherein the clustering parameters further comprise a maximum size; and wherein reducing the size of at least one territory comprises reducing the size of at least one territory based upon the maximum size.

14. The computer-readable storage medium of claim 13, wherein reducing the size of at least one territory based upon the maximum size comprises reducing, via execution of a Gaussian mixture clustering algorithm, the size of at least one territory based upon the maximum size.

15. The computer-readable storage medium of claim 14, wherein conditionally exchanging the assignment of at least one of the plurality of job dense areas from the first territory of the plurality of territories to the second territory of the plurality of territories comprises exchanging the assignment of at least one of the plurality of job dense areas from the first territory of the plurality of territories to the second territory of the plurality of territories to improve a balance of a number of jobs to a number of technicians among the first territory and the second territory.

16. The computer-readable storage medium of claim 14, wherein conditionally exchanging the assignment of at least one of the plurality of job dense areas from the first territory of the plurality of territories to the second territory of the plurality of territories comprises exchanging the assignment of at least one of the plurality of job dense areas from the first territory of the plurality of territories to the second territory of the plurality of territories to improve a distance between at least one job of the plurality of jobs and a nearest technician.

17. A territory assignment optimization system comprising:
a processor; and
a memory comprising computer-executable instructions that, when executed by the processor, cause the processor to perform operations comprising
receiving job data that identifies a plurality of jobs at a plurality of customer locations throughout a geographical area,
receiving clustering parameters,
identifying, via execution of a data clustering algorithm, a plurality of job dense areas within the geographical area based upon the job data and the clustering parameters,
reducing a size of at least one territory of a plurality of territories, wherein each territory of the plurality of territories comprises a portion of the plurality of job dense areas, and
conditionally exchanging an assignment of at least one of the plurality of job dense areas from a first territory of the plurality of territories to a second territory of the plurality of territories.

18. The territory assignment optimization system of claim 17, wherein:
the clustering parameters comprise a distance measurement and a number of points;
the distance measurement identifies a distance from a specific location; and
the number of points identify a number of other jobs that should be within the distance from the specific location.

19. The territory assignment optimization system of claim 18, wherein the clustering parameters further comprise a maximum size; and wherein reducing the size of at least one territory comprises reducing the size of at least one territory based upon the maximum size.

20. The territory assignment optimization system of claim 18, wherein conditionally exchanging the assignment of at least one of the plurality of job dense areas from the first territory of the plurality of territories to the second territory of the plurality of territories comprises exchanging the assignment of at least one of the plurality of job dense areas from the first territory of the plurality of territories to the second territory of the plurality of territories to if:
exchanging the assignment improves a balance of a number of jobs to a number of technicians among the first territory and the second territory; or
exchanging the assignment improves a distance between at least one job of the plurality of jobs and a nearest technician.
